(19) United States
(12) Patent Application Publication
(10) Pub. No.: US 2026/0220431 A1
(43) Pub. Date: Jul. 30, 2026

(54) ANOMALY DETECTION IN TIME-SERIES DATA

(71) Applicant: Walmart Apollo, LLC, Bentonville, AR (US)

(72) Inventors: Ninh Hai Do, San Francisco, CA (US); Yilan Qu, San Francisco, CA (US)

(21) Appl. No.: 19/037,934

(22) Filed: Jan. 27, 2025

(51) Int. Cl. G06N 3/0455; G06N 3/088; G06Q 30/0226

(52) U.S. Cl. CPC G06N 3/0455; G06N 3/088; G06Q 30/0233

(57) ABSTRACT

Example implementations related to automated anomaly detection in time-series datasets are disclosed. In an example, a request for an automated redemption operation is received. The request includes a plurality of time-series data elements. A reconstruction error is generated for the request using a trained autoencoder model that receives the plurality of time-series data elements. The reconstruction error is representative of a difference between the plurality of time-series data elements and a reconstructed plurality of time-series data elements generated by the trained autoencoder model. In response to determining the reconstruction error is above the predetermined threshold and that the request for the automated redemption operation satisfies at least one anomaly detection rule, execution of the automated redemption operation is prevented.

### TECHNICAL FIELD

This application relates generally to identifying anomalies in time-series datasets, and more particularly, to identifying anomalies using reconstructions of time-series datasets.

### BACKGROUND

Some automated systems receive inputs that generate time-series datasets including data elements each associated with a time stamp. These systems may enable input of time-series data and generate one or more outputs. Current automated systems may allow input through scanning of user-provided data inputs such as printouts or other documents.

### BRIEF DESCRIPTION OF THE DRAWINGS

Various examples will be described below with reference to the following figures.

FIG. 1 depicts an example system for anomaly detection in time-series data, in accordance with some embodiments.

FIG. 2 depicts an example system for training and deploying an autoencoder model, in accordance with some embodiments.

FIG. 3 depicts a plurality of variable-length time-series datasets, in accordance with some embodiments.

FIG. 4 depicts a flow diagram illustrating an example method of anomaly detection in time-series data, in accordance with some embodiments.

FIG. 5 depicts a flow diagram illustrating an example method of redemption authorization using a pre-generated blocklist, in accordance with some embodiments.

FIG. 6 depicts an example system with a machine-readable medium that includes instructions for anomaly detection in time-series datasets, in accordance with some embodiments.

FIG. 7 depicts an example system with a machine-readable medium that includes instructions for redemption authorization using a pre-generated blocklist, in accordance with some embodiments

FIG. 8 depicts an example computer system that implements one or more processes, in accordance with some embodiments.

### DETAILED DESCRIPTION

User input systems may enable users to convert user-retained data sources, such as receipts or other documents, into time-series data that enables additional operations, such as redemption operations. The user-retained data sources may include convertible data elements, such as identification of one or more item interactions or activities (e.g., a purchase transaction) and a time stamp corresponding to the time of the activity or interaction. The user input systems may scan or otherwise obtain data from the user-retained data sources and perform one or more validation and/or redemption processes based on the obtained time-series dataset. Because the inputs are obtained from user-retained data sources, anomalies may occur when a user attempts to input data elements not associated with the user or request redemption operations outside an expected set.

The disclosed systems and methods enable anomaly detection by utilizing a data pipeline including at least one autoencoder model to identify anomalous time-series datasets. The data pipeline enables input of variable-length time-series datasets and batch processing of requested validation and redemption operations. For example, the disclosed systems and methods may identify anomalies in time-series datasets using an autoencoder model and reconstructions of time-series datasets. The autoencoder model provides an adjustable detection mechanism for identifying normal patterns in time-series datasets and/or identifying anomalous time-series datasets. The autoencoder model may be trained to generate a reconstruction of a time-series dataset using unlabeled inputs to enable a broad application to time-series signals. The data pipeline and autoencoder model may provide flexibility, compared to systems using fixed rule sets, and may provide an end-to-end solution for anomaly detection across multiple platforms, allowing for unification of anomaly detection.

In various embodiments, a system including a processor and non-transitory memory is disclosed. The non-transitory memory stores instructions that, when executed, cause the processor to receive a request for an automated redemption operation. The request includes a plurality of time-series data elements. A reconstruction error is generated for the request using a trained autoencoder model that receives the plurality of time-series data elements. The reconstruction error is representative of a difference between the plurality of time-series data elements and a reconstructed plurality of time-series data elements generated by the trained autoencoder model. The instructions cause the processor to determine whether the reconstruction error is above a predetermined threshold. In response to determining that the reconstruction error is above the predetermined threshold, the processor further determines whether the request for the automated redemption operation satisfies at least one anomaly detection rule. In response to determining that the request for the automated redemption operation satisfies the at least one anomaly detection rule, execution of the automated redemption operation is prevented.

In various embodiments, a computer-implemented method is disclosed. The computer-implemented method includes a step of receiving a request for an automated redemption operation. The request includes a plurality of time-series data elements. The computer-implemented method further includes a step of generating a reconstruction error for the request using a trained autoencoder model that receives the plurality of time-series data elements. The reconstruction error is representative of a difference between the plurality of time-series data elements and a reconstructed plurality of time-series data elements generated by the trained autoencoder model. The computer-implemented method further includes steps of determining whether the reconstruction error is above a predetermined threshold and, in response to determining the reconstruction error is above the predetermined threshold, determining whether the request for the automated redemption operation satisfies at least one anomaly detection rule. In response to determining that the request for the automated redemption operation satisfies the at least one anomaly detection rule, execution of the automated redemption operation is prevented.

In some embodiments, a non-transitory computer-readable medium storing instructions is disclosed. The instructions, when executed by at least one processor, cause a device to perform operations including receiving a request for an automated redemption operation. The request includes a plurality of time-series data elements. The instructions further cause the device to perform operations including generating a reconstruction error for the request using a trained autoencoder model that receives the plurality of time-series data elements. The reconstruction error is representative of a difference between the plurality of time-series data elements and a reconstructed plurality of time-series data elements generated by the trained autoencoder model. The instructions further cause the device to perform operations including determining whether the reconstruction error is above a predetermined threshold and, in response to determining that the reconstruction error is above the predetermined threshold, determining whether the request for the automated redemption operation satisfies at least one anomaly detection rule. In response to determining that the request for the automated redemption operation satisfies the at least one anomaly detection rule, execution of the automated redemption operation is prevented.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired or wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems, as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for anomaly detection in time-series datasets. In various embodiments, an end-to-end anomaly detection system includes a data pipeline for receiving variable-length time-series datasets and performing reconstruction of the variable-length time-series datasets using a trained autoencoder model. A reconstruction error between an input time-series dataset and the reconstructed time-series dataset above a predetermined threshold may be representative of an anomalous time-series dataset. One or more additional anomaly detection rules may be applied to time-series datasets that are identified as potentially anomalous based on the reconstruction error. When a time-series dataset is identified as anomalous, execution of a corresponding operation (e.g., a redemption operation) may be prevented by the system.

In some embodiments, systems, and methods for anomaly detection in time-series datasets include one or more trained autoencoder models. The trained autoencoder model may include one or more trained frameworks, such as one or more trained variable-length Long Short-Term Memory (LSTM) autoencoder frameworks. A trained autoencoder model may be generated using an unlabeled training dataset (e.g., unsupervised learning) to identify patterns within expected (e.g., non-anomalous) time-series datasets to enable reconstruction of a time-series dataset within an expected reconstruction error. In some embodiments, the autoencoder model is trained on expected time-series datasets such that a reconstruction of an unexpected (e.g., anomalous) time-series dataset results in a reconstruction error above a predetermined reconstruction error threshold. The autoencoder model may process batch sets of variable-length time-series datasets.

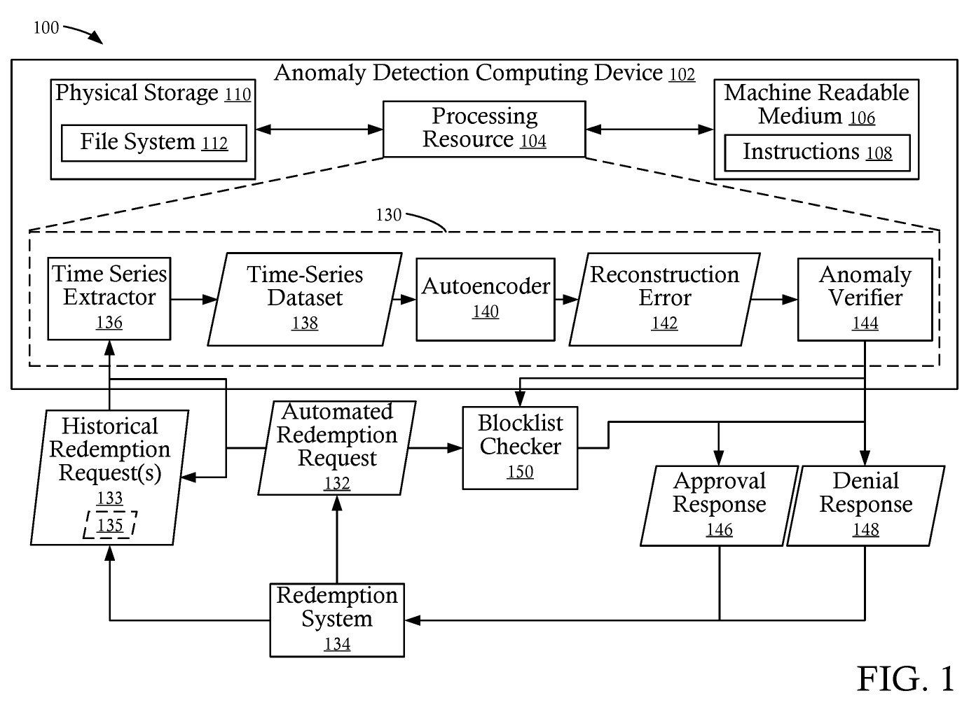

FIG. 1 depicts an example system 100 that provides anomaly detection in time-series datasets, in accordance with some embodiments. The system 100 includes an anomaly detection computing device 102 that provides anomaly detection of time-series datasets. The anomaly detection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The anomaly detection computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (e.g., programming or software code) stored on machine-readable medium 106 to perform functions of the anomaly detection computing device 102, such as time-series data processing, anomaly detection, autoencoder model training, or application of a rules engine. The instructions 108 may include instructions for implementing one or more models. In some embodiments, and as will be described further herein below, the anomaly detection computing device 102 may execute one or more models, processes, or algorithms, such as a deep learning–based autoencoder model (e.g., as implemented as machine-readable instructions) to generate a reconstruction of a received time-series dataset and determine a reconstruction error between the input time-series dataset and the reconstructed time-series dataset.

The anomaly detection computing device 102 may also include other hardware components, such as physical storage 110. Physical storage 110 may include any physical storage device such as a hard disk drive, a solid-state drive, or the like, or a plurality of such storage devices (e.g., an array of disks), and may be locally attached (e.g., installed) in the anomaly detection computing device 102. In some implementations, physical storage 110 may be accessed as a block storage device.

In some cases, the anomaly detection computing device 102 may include a local file system 112 that may be implemented as a layer on top of the physical storage 110. For example, an operating system may be executing on the anomaly detection computing device 102 (by virtue of the processing resource 104 executing certain instructions 108 related to the operating system) and the operating system may provide a file system 112 to store data on the physical storage 110.

The anomaly detection computing device 102 may be in communication with one or more additional devices over one or more network channels. For example, in various embodiments, the anomaly detection computing device 102 may be in communication with a web server, a cloud-based engine including one or more processing devices that may be provisioned for use, a database, a workstation, and/or any other suitable system or device. The anomaly detection computing device 102 may similarly be in communication, either directly or indirectly, with one or more user computing devices operatively coupled over the network. The other computing systems may be similar to the anomaly detection computing device 102 and may each include at least a processing resource and a machine-readable medium.

In some embodiments, an automated redemption request 132 is received by an anomaly detection and redemption validation process 130 executed on the anomaly detection computing device 102, for example, as executed by the processing resource 104. The automated redemption request 132 may be generated by a redemption system 134 that enables input of data elements from one or more data sources. The automated redemption request 132 may be included in a set of historical redemption requests 133 provided to the anomaly detection and redemption validation process 130 as a batch set for processing and/or as a training dataset. The automated redemption request 132 and/or the historical redemption requests 133 each include one or more data elements 135. The one or more data elements 135 may be obtained, for example, via a redemption system 134.

In some embodiments, the anomaly detection and redemption validation process 130 includes a time-series extractor 136 (e.g., a time series extractor and builder) that generates a time-series dataset 138 based on the one or more data elements 135. The data elements 135 may be obtained from physical data sources, such as printed documents, containing interpretable data elements. Each data element 135 may be associated with a corresponding time stamp. For example, the redemption system 134 may enable scanning of printed receipts containing identifiers for one or more purchased items and a time stamp corresponding to the time of the purchase interaction. In some embodiments, the scanned receipt is corelated to stored transaction date including one or more time stamps. The time series extractor 136 may receive the scanned data, for example, via the automated redemption request 132, and may generate a time-series dataset 138 including data elements for one or more items from one or more receipts, each associated with the time indicated by the time stamp of a corresponding receipt. Although embodiments are discussed herein including scanned data elements, it will be appreciated that the redemption system 134 may obtain data element from any suitable data inputs.

In some embodiments, the redemption system 134 includes a system remote from the anomaly detection computing device 102. For example, the redemption system 134 may include a kiosk or other computing device located at a first location and the anomaly detection computing device 102 may include a server or computing device located at a second location that is remote to the first location. In some embodiments, the redemption system 134 may be integrated into and/or included with the anomaly detection computing device 102.

In some embodiments, the automated redemption request 132 includes additional redemption data corresponding to a requested redemption operation. For example, in some embodiments, the redemption system 134 may enable redemption operations with selectable outputs. As one non-limiting example, a redemption system may enable a redemption operation based on scanned receipt data that provides an output in the form of store credit, cash value, or other selectable monetary outputs. The automated redemption request 132 may include, for example, additional data elements included in or separate from the time-series dataset 136, representative of the selected redemption operation, a time of input for the data elements, a user identifier associated with a user requesting the redemption operation, a time elapsed between transactions, and/or any other suitable data related to the data elements and/or the requested redemption operation. The redemption system 134 may enable any suitable redemption operation, such as, for example, a reward redemption operation, a reward earning operation, a purchase operation, etc. Although embodiments are discussed herein including redemption operations utilizing scanned data, it will be appreciated that the automated redemption request 132 may be related to any suitable time-series dataset and/or operation.

The time-series dataset 138 may be included as a pre-generated time-series dataset within the automated redemption request and/or may be generated by the time-series extractor 136 based on other data, such as scanned data inputs, included with the automated redemption request 132. The time-series dataset 138 may be of a variable length based on the number of data elements provided for the corresponding redemption operation. For example, a time-series dataset 138 may include three or more time-series data elements, each representative of an interaction at a corresponding time as obtained by the redemption system 134. The time-series dataset 138 may include one or more features representative of a time elapsed between data elements.

In some embodiments, the extracted time-series dataset 138 is provided to an autoencoder 140. The autoencoder 140 may include any suitable autoencoder framework, such as a variable-length LSTM autoencoder framework. The autoencoder 140 receives the time-series dataset 138 and generates a reconstruction of the time-series dataset 138 by first encoding the time-series dataset 138 and subsequently decoding the encoding to generate the reconstruction. In some embodiments, the autoencoder 140 is generated using an expected range of time-series inputs such that reconstructions of non-anomalous (e.g., expected or within-distribution) time-series datasets are substantially similar to the initial input time-series dataset 138 and anomalous (e.g., unexpected or out-of-distribution) time-series datasets are incorrectly reconstructed with higher error rates.

In some embodiments, the autoencoder 140 compares the input time-series dataset 138 to the reconstructed time-series dataset to generate a reconstruction error 142. The reconstruction error 142 is representative of a difference (e.g., a delta) between the input time-series dataset 138 and the reconstructed time-series dataset. In some embodiments, a higher reconstruction error 142 corresponding to a greater difference between the input time-series dataset 138 and the reconstructed time-series dataset indicates an anomalous dataset. The reconstruction error 142 may include a single numeric value, a set of numeric values, and/or any other suitable representation of the difference between the input time-series dataset 138 and the reconstruction.

The reconstruction error 142 may be provided to an anomaly verifier 144 that determines whether the time-series dataset is anomalous. For example, in some embodiments, the anomaly verifier 144 implements a first-level anomaly check based on the reconstruction error 142. When the reconstructions error 142 is above a predetermined threshold (or, in some embodiments, equal to or above the predetermined threshold), the anomaly verifier 144 may identify the corresponding time-series dataset 138 as potentially anomalous. Alternatively, when the reconstruction error 142 is below the predetermined threshold (or, in some embodiments, equal to or below the predetermined threshold), the anomaly verifier 144 may identify the corresponding time-series dataset 138 as not anomalous.

In some embodiments, the anomaly verifier 144 may implement a second-level anomaly check based on, for example, one or more anomaly detection rules. For example, the anomaly verifier 144 may implement a rules engine including one or more predetermined anomaly detection rules. An automated redemption request 132 may be provided to the rules engine for anomaly detection when the reconstruction error 142 is above the predetermined threshold. By limiting the number of requests sent to a rules engine, for example using the reconstruction error 142, the disclosed systems and methods provide a reduction of the resources required for performing anomaly detection, as calculation of the reconstruction error 142 utilizes fewer resources than applying a rules engine to each automated redemption request 132.

In some embodiments, the multitiered anomaly check implemented by the anomaly verifier 144 allows the anomaly verifier 144 to adapt to changes in anomalous behavior with respect to the time-series datasets while maintaining certain known rules or exceptions for identifying anomalous time-series datasets or anomalous requests for redemption. For example, in some embodiments, the autoencoder 140 may be retrained or tuned on a periodic basis (e.g., once a day or once a week) using recent (e.g., since the last retraining) known non-anomalous time-series datasets. Periodic retraining of the autoencoder 140 on recent known non-anomalous time-series datasets ensures that the autoencoder 140 generates low-error reconstructions for non-anomalous time-series datasets as the time-series datasets adapt over time. The anomaly verifier 144 may implement a first-level anomaly check based on a reconstruction error 142 generated by the adapted autoencoder 140. When the reconstruction error 142 is above a predetermined threshold, the anomaly verifier 144 may implement a second-level anomaly check based on a set of rules that exclude potentially anomalous time-series datasets as valid and/or that expressly identify known anomalous time-series datasets.

In some embodiments, the anomaly verifier 144 includes a current session verification that verifies an automated redemption request 132 at the time of the request. For example, an automated redemption request 132 may be provided to an anomaly detection and redemption validation process 130 when the automated redemption request is initially generated. When the anomaly verifier 144 determines that the request for the redemption operation is not anomalous (e.g., the reconstruction score is below a predetermined threshold and/or the request satisfies one or more rules indicating the request is non-anomalous), an approval response 146 is generated and transmitted to the redemption system 134. Alternatively, when the anomaly verifier 144 determines that the request for the redemption operation is anomalous (e.g., the reconstruction score is above a predetermined threshold and the request does not satisfy any rules indicating the request is non-anomalous), a denial response 148 is generated and transmitted to the redemption system 134. In some embodiments, the denial response 148 prevents or stops execution of the requested redemption operation. In some embodiments, an approval response 146 is required before the redemption system 134 executes the requested redemption operation.

In some embodiments, the anomaly verifier 144 includes historic session verification that verifies automated redemption requests, such as automated redemption request 132 and/or historical redemption requests 133, at a time after the automated redemption request has been processed. The anomaly verifier 144 may operate on historical redemption requests 133 as a batch process and may generate a model output related to identified anomalous automated redemption requests. In some embodiments, the model output includes a blocklist that is provided to a blocklist checker 150. The blocklist may include user identifiers (e.g., usernames, legal names, or other user identifiable information) for users associated with one or more anomalous automated redemption requests.

In some embodiments, a blocklist may be updated and provided to a blocklist checker 150 at a predetermined interval, e.g., once a day, one a week, etc. When an automated redemption request 132 is generated, the automated redemption request 132 is additionally or alternatively provided to the blocklist checker 150, which compares the user associated with the current automated redemption request 132 to the users included in the blocklist. When a user associated with a current automated redemption request 132 is included on the blocklist, the blocklist checker 150 generates a denial response 148 and prevents execution of the automated redemption operation. Alternatively, when a user associated with a current automated redemption request 132 is not included on the blocklist, the blocklist checker 150 generates an approval response and the automated redemption operation is implemented.

In some embodiments, the redemption system 134 performs one or more additional operations responsive to receiving a denial response 148. For example, in some embodiments, the redemption system 134 may generate a flag or other data element corresponding to the user who attempted to perform the redemption operation in order to ensure future redemption operations by the same user are reviewed. As another example, in some embodiments, the redemption system 134 may generate a flag or other data element for the scanned receipts and/or transactions represented by the scanned receipts, indicating that such transactions are no longer valid for redemption operations. Although specific embodiments are discussed herein, it will be appreciated that any suitable operations may be performed by the redemption system 134 and/or the anomaly detection computing device 102 in response to determining that an automated redemption request 132 is anomalous.

As one non-limiting example, in some embodiments, the redemption system 134 may include a receipt redemption system tied to one or more rewards programs associated with a retailer. The redemption system 134 may include a scanner configured to scan paper receipts provided to users at the conclusion of purchase interactions. The receipts may include item identifiers for various items obtained during the purchase transaction and a time stamp indicating a time of the purchase transaction. The redemption system 134 may scan one or more receipts provided by a user and generate scan data representative of the scanned receipts. For example, the scan data may include images of the scanned receipts, text data extracted from the scanned receipts, bar code data extracted from the scanned receipts, etc. As another example, in some embodiments, the redemption system 134 and/or the anomaly detection and redemption validation process 130 may obtain additional system data, e.g., system metadata or transaction metadata, associated with a scanned receipt, such as total receipt amount, store location, and/or any other suitable metadata.

Continuing the above example, in some embodiments, a user may select a redemption operation including a rewards payout in the form of monetary compensation (e.g., a payment of money based on items included in the purchase transactions of the scanned receipts). The redemption system 134 may generate an automated redemption request 132 representative of the rewards payout operation and transmit the automated redemption request 132 to an anomaly detection and redemption validation process 130. The automated redemption request 132 may include the scan data and/or scan-relevant metadata.

The automated redemption request 132 may be provided to a blocklist checker 150, which determines whether a user associated with the automated redemption request 132 is included in a blocklist. When the blocklist checker 150 determines the user is not included on the blocklist, the blocklist checker 150 transmits an approval response 146 to the redemption system 134 that enables execution of the rewards payout operation and allows the user to obtain the rewards payout. Alternatively, when the blocklist checker 150 determines the automated redemption request is anomalous, the blocklist checker 150 transmits a denial response 148 that prevents or stops execution of the rewards payout operation.

Additionally or alternatively, the automated redemption request 132 may be received by the time-series extractor 136, which extracts a time-series dataset 138 from the scan data. For example, in some embodiments, the time-series extractor 136 generates a time-series datasets (e.g., by combining existing time-series data maintained by a network system with obtained scan data). The time-series dataset 138 may include time-series elements representative of one or more purchase interactions and/or item interactions obtained from the scan data (e.g., obtained from the scanned receipts). The time-series dataset 138 may be provided to the autoencoder 140, which generates a reconstruction of the time-series dataset and compares the reconstruction to the initial input time-series dataset 136 to generate a reconstruction error 142. The reconstruction error and the automated redemption request 132 for the rewards payout operation are provided to the anomaly verifier 144.

The anomaly verifier 144 may determine whether the reconstruction error is above a predetermined threshold and, if so, provide the automated redemption request 132 for the rewards payout operation to a rules engine that implements one or more anomaly detection and/or exclusion rules. For example, the anomaly verifier 144 may include a rules engine that implements one or more transactional limit rules (e.g., allowing all redemption requests below a certain monetary value), one or more user rules (e.g., allowing or preventing all redemption requests from an identified user), etc. In some embodiments, the anomaly verifier 144 updates a blocklist provided to a blocklist checker 150 in response to the output of the anomaly verifier 144. Alternatively or additionally, the anomaly verifier 144 may be provide a current session response such that when the anomaly verifier 144 determines the automated redemption request is not anomalous, the anomaly verifier 144 transmits an approval response 146 to the redemption system 134 that enables execution of the rewards payout operation and allows the user to obtain the rewards payout and when the anomaly verifier 144 determines the automated redemption request is anomalous, the anomaly verifier 144 transmits a denial response 148 that prevents or stops execution of the rewards payout operation.

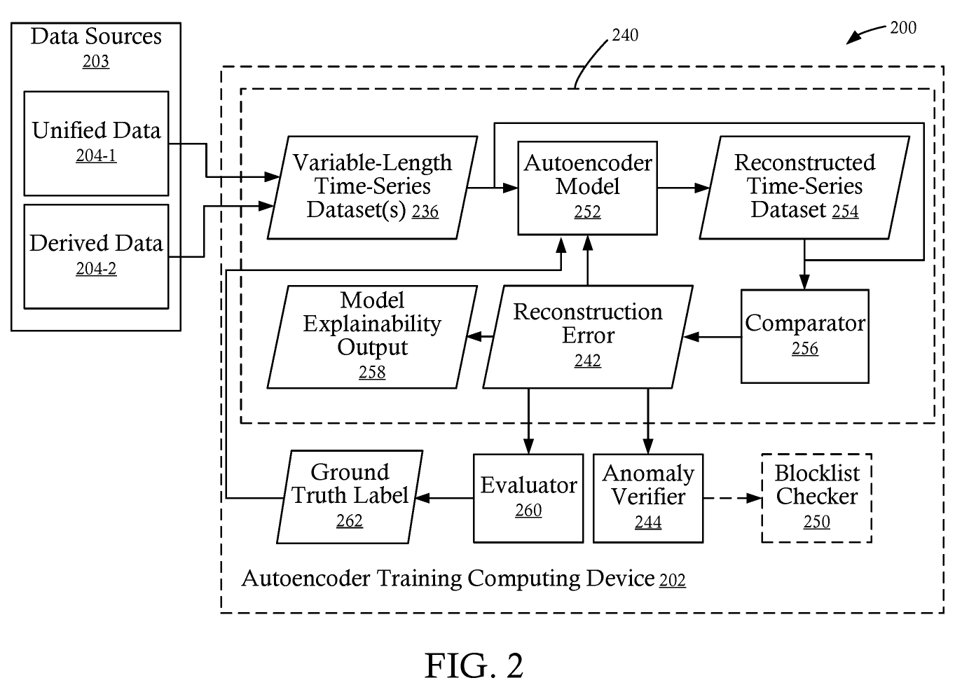

FIG. 2 depicts an example system 200 for training and deploying an autoencoder model, in accordance with some embodiments. The system 200 includes an autoencoder training computing device 202 that is similar to and/or may be integrated as part of the anomaly detection computing device 102 discussed with respect to FIG. 1. In some embodiments, one or more data inputs, such as unified data 204-1 and derived data 204-2 (collectively “data inputs 204”), are received from one or more data sources 203. A data source 203 may include, but is not limited to, a database, a data repository, a remote system, or a current session input.

In some embodiments, unified data 204-1 includes datasets aggregated from multiple input sources such as internal data sources and/or external data sources. The unified data may include time-series datasets and/or features of time-series datasets generated based on one or more input sources. For example, as one non-limiting example, data corresponding to a first user may be received from an internal data source and an external data source. Unified data 204-1 may include a time-series dataset associated with the first user incorporating data elements received from each of the internal data source and the external data source. Although specific embodiments are discussed herein, it will be appreciated that unified data 204-1 may be generated from any number of data sources and/or data elements.

In some embodiments, derived data 204-2 includes data elements or data features derived from one or more of the data elements in the unified data 204-1. Derived data 204-2 may include elements derived from a single unified data element, a single type of unified data element, a combination of types of unified data elements, one or more other derived data elements, etc. The derived data 204-2 may be generated as a batch process and stored in a derived data store and/or generated at the time of execution.

In some embodiments, the data inputs 204 are received by an autoencoder 240 as variable-length time-series dataset 236. The variable-length time-series data 236 may include data elements and corresponding time stamps aggregated from the unified data 204-1 and/or the derived data 204-2. Each variable-length time-series dataset 236 may include a variable length, e.g., a variable number of data elements or data points. For example, in various embodiments, a time-series data input may include three or more data elements and corresponding time stamps.

Each of the variable-length time-series datasets 236 are provided to an autoencoder model 252. The autoencoder model 252 may include one or more trained autoencoder frameworks, such as a variable-length LSTM autoencoder framework. The autoencoder model 252 generates a reconstructed time-series dataset 254 by applying a series of encoding layers to first encode a received time-series dataset and a series of decoding layers to re-create the time-series dataset from the encoding. The reconstructed time-series dataset 254 and a corresponding initial variable-length time-series dataset 236 may each be provided to a comparator 256. In some embodiments, the autoencoder model 252 is trained to re-create expected (e.g., in-distribution or non-anomalous) time-series datasets.

In some embodiments, the comparator 256 compares the initial variable-length time-series dataset 236 to the corresponding reconstructed time-series dataset 254 to identify a reconstruction error 242. The reconstruction error 242 represents a difference between the initial variable-length time-series dataset 236 and the corresponding reconstructed time-series dataset 254. A reconstruction error 242 may increase, for example, due to data elements being different, time stamps being different, temporal features derived from time stamps being different, and/or any other measurable difference. As discussed above, the autoencoder model 252 is trained to re-create expected time-series datasets such that unexpected (e.g., out-of-distribution or anomalous) time-series datasets have a higher reconstruction error 242.

In some embodiments, the autoencoder model and/or the comparator 256 generate model explainability output 258 that identifies one or more reasons or contributing factors for the reconstruction error 242. As one non-limiting example, in some embodiments, the comparator 256 may identify each of the differences that contributed to the generated reconstruction error 242. As another non-limiting example, in some embodiments, the comparator 256 may identify the top N contributing differences (e.g., the top N features of the time-series dataset 254 having the most significant impact) to the reconstruction error 242, where N is an integer greater than zero. The model explainability output 258 allows investigation and confirmation of the reconstruction error 242, and therefore the corresponding identification of anomalous time-series datasets, to ensure proper operation of the autoencoder model 252.

In some embodiments, the reconstruction error 242 is provided to an anomaly verifier 244, which is similar to the anomaly verifier 144 discussed above with respect to FIG. 1. The anomaly verifier 244 may apply one or more verification mechanisms, such as a rules engine that applies one or more confirmation rules to establish whether the initial variable-length time-series dataset 236 is anomalous. In some embodiments, the anomaly verifier 244 generates one of a denial response when the anomaly verifier 244 determines that the corresponding variable-length time-series dataset 236 is anomalous or an approval response when the anomaly verifier 244 determines the corresponding variable-length time-series dataset 236 is non-anomalous. Additionally and/or alternatively, in some embodiments, the anomaly verifier 244 generates a blocklist that is provided to a blocklist checker 250, as discussed above with respect to blocklist checker 150 of FIG. 1.

In some embodiments, the reconstruction error 242 is provided to an evaluator 260 that compares the reconstruction error 242 and/or corresponding response output with a ground truth label 262. The ground truth label 262 may be representative of whether a variable-length time-series dataset 236 was actually anomalous, for example, as confirmed after further review. The ground truth label 262 and corresponding reconstruction error 242 may be provided for further training, retraining, and/or refinement of the autoencoder model 252.

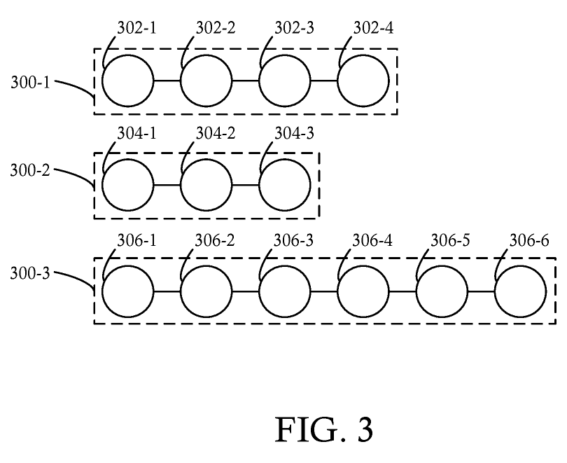

FIG. 3 depicts a plurality of variable-length time-series datasets 300-1 to 300-3 (collectively “time-series datasets 300”), in accordance with some embodiments. As illustrated in FIG. 3, the first time-series dataset 300-1 includes a plurality of first data elements 302-1 to 302-4 (collectively “first data elements 302”), the second time-series dataset 300-2 includes a plurality of second data elements 304-1 to 304-3 (collectively “second data elements 304”), and the third time-series dataset 300-3 includes a plurality of third data elements 306-1 to 306-6 (collectively “third data elements 306”). The first time-series dataset 300-1 has a length of four, e.g., is four data elements long, the second time-series dataset 300-2 has a length of three, and the third time-series dataset 300-3 has a length of six. The autoencoders discussed herein, such as autoencoders 140, 240, are trained to receive time-series datasets of variable length such that each of the time-series datasets 300 may be provided to a corresponding autoencoder without needing to be truncated, padded, or otherwise adjusted.

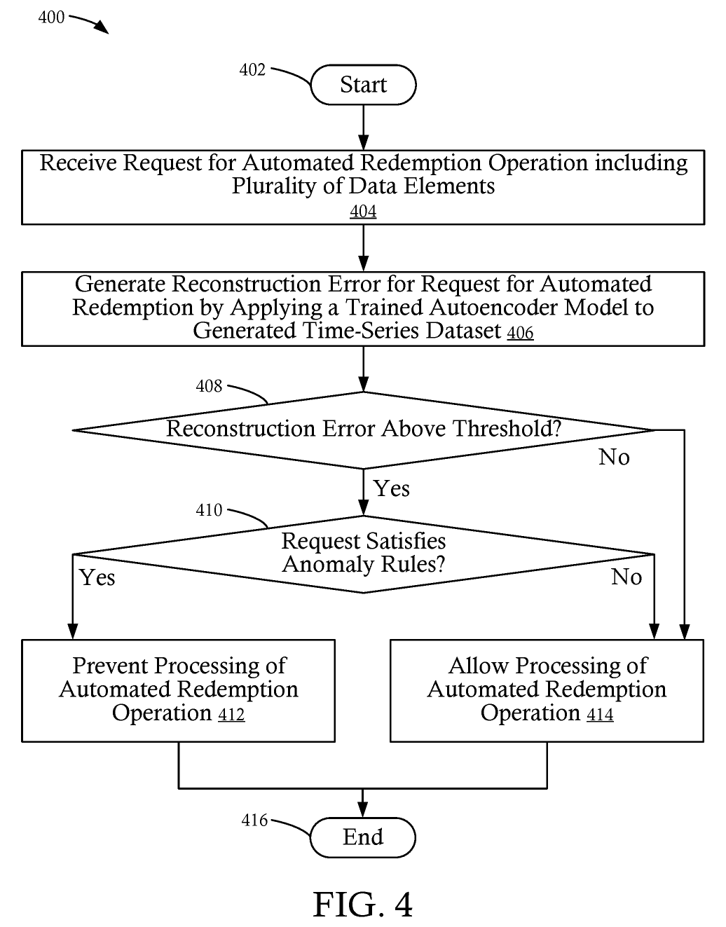

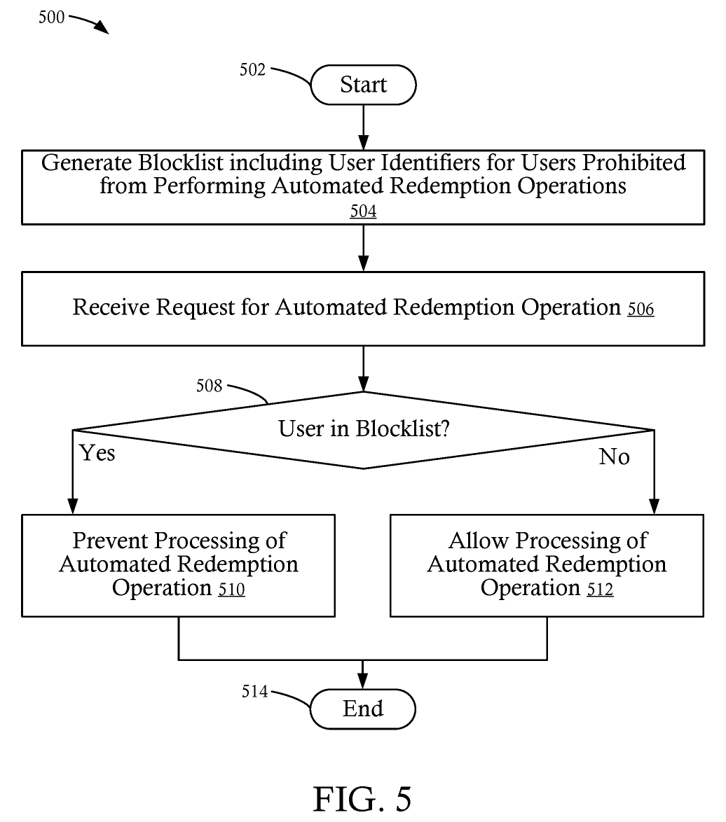

FIGS. 4 and 5 are flow diagrams depicting example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 4 and 5 may be implemented in the form of executable instructions stored on a machine-readable medium and executed by a processing resource and/or in the form of electronic circuitry. For example, aspects of the methods may be described below as being performed by an anomaly detection and redemption validation process, an example of which may be the anomaly detection and redemption validation process 130 running on a hardware processing resource 104 of the anomaly detection computing device 102 described above. Additionally, other aspects of the methods described below may be described with reference to other elements shown in FIG. 1 for non-limiting illustration purposes.

FIG. 4 depicts a flow diagram illustrating an example method 400 of anomaly detection in time-series data, in accordance with some embodiments. Method 400 starts at block 402 and continues to block 404, where a request for an automated redemption operation is received. The request includes a plurality of data elements. For example, the request may include a dataset that includes, represents, or embodies one or more data elements that may be combined with an existing time-series dataset and/or temporal features to generate a time-series dataset. In some embodiments, a time-series dataset may be constructed from received data included in a request. As another example, in some embodiments, the plurality of data elements are provided as a time-series dataset in the request.

At block 406, a reconstruction error is generated for the request by applying a trained autoencoder model to a time-series dataset including the data elements associated with the request. The trained autoencoder model may include any suitable autoencoder framework, such as a trained variable-length LSTM autoencoder framework. In some embodiments, the trained autoencoder model generates an encoding of the time-series dataset and subsequently generates a reconstruction of the time-series dataset based on the generated encoding. The reconstruction may be compared to the initial time-series dataset associated with the request to generate the reconstruction error. The reconstruction error may be representative of one or more differences between the reconstruction and the initial time-series dataset.

At block 408, a determination is made whether the reconstruction error is above (or, in some embodiments, above or equal to) a predetermined threshold. When the reconstruction error is above the predetermined threshold, the method 400 proceeds to block 410, where a determination is made whether the request for automated redemption satisfies one or more anomaly rules. For example, as discussed above, an anomaly verifier may implement a rules engine to apply one or more rules to confirm whether the request for the automated redemption operation is anomalous and/or non-anomalous (for example, based on the time-series dataset and/or additional data included in the request). When the request satisfies one or more rules indicating the request is anomalous (or, conversely, does not satisfy one or more rules indicating the request is non-anomalous), the method 400 proceeds to block 412 and processing of the automated redemption operation is prevented or stopped. Alternatively, when the request does not satisfy one or more rules indicating the request is anomalous (or, conversely, satisfies one or more rules indicating the request is non-anomalous), the method 400 proceeds to block 414 and processing of the automated redemption operation is allowed.

With reference again to block 408, when the reconstruction error is below (or, in some embodiments, below or equal to) the predetermined threshold, the method 400 proceeds directly to block 414 and processing of the automated redemption operation is allowed. After execution of either block 412 or block 414, the method 400 proceeds to block 416 and ends.

FIG. 5 depicts a flow diagram illustrating an example method 500 of redemption authorization using a pre-generated blocklist, in accordance with some embodiments. Method 500 starts at block 502 and continues to block 504, where a blocklist including user identifiers for one or more users prohibited from performing redemption operations is generated. The blocklist may be generated by applying an anomaly detection and redemption validation process, such as the anomaly detection and redemption validation process 130 discussed above with respect to FIG. 1, to one or more historic redemption requests associated with one or more users. In some embodiments, when the anomaly detection and redemption validation process identifies an anomalous redemption request, a user associated with the anomalous redemption request may be added to a blocklist. The anomaly detection and redemption validation process may require a threshold number of anomalous redemption requests, such as one, two, three, etc. anomalous redemption requests, before a user is added to a blocklist.

At block 506, a request for an automated redemption operation is received. The request may be received from any suitable system, such as a redemption system that allows a user to scan or otherwise input data contained in one or more physical elements, e.g., documents, to the system. The request may be a request generated during a current (e.g., simultaneously executed) session. The request for the automated redemption operation includes one or more user identifiers, such as a username, an individual name, or other identifying information.

At block 508, a determination is made whether the user associated with the redemption request is identified in the blocklist. When the user is included in the blocklist, the method 500 proceeds to block 510 and processing of the automated redemption operation is prevented (e.g., the request is not authorized). Alternatively, when the user is not included in the blocklist, the method 500 proceeds to block 512 and processing of the automated redemption operation is allowed (e.g., the request is authorized). After block 510 or block 512 is executed, the method 500 proceeds to block 514 and the method 500 ends.

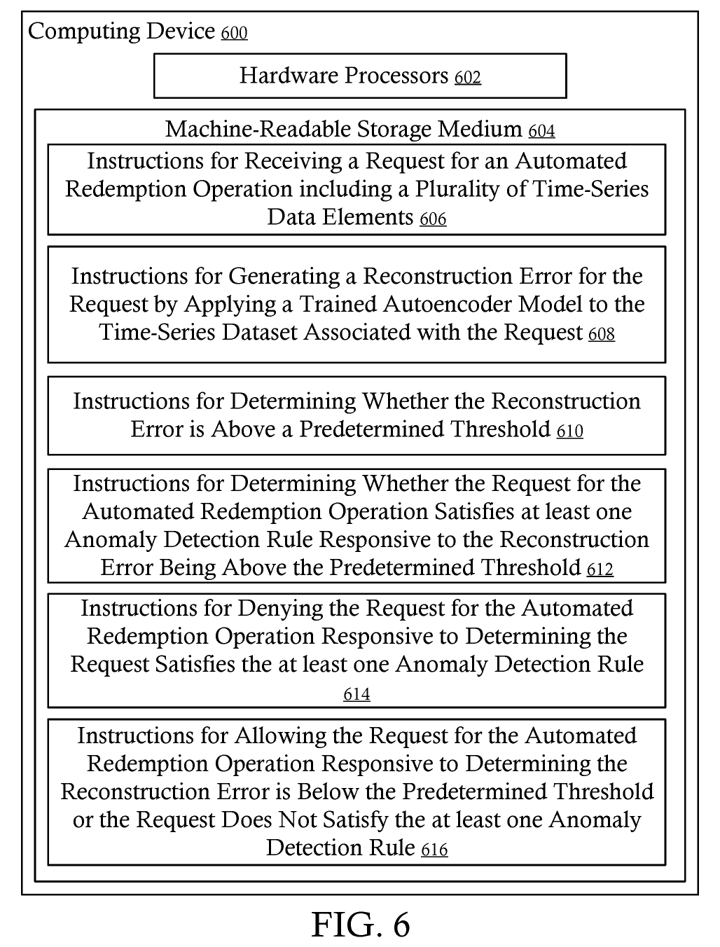

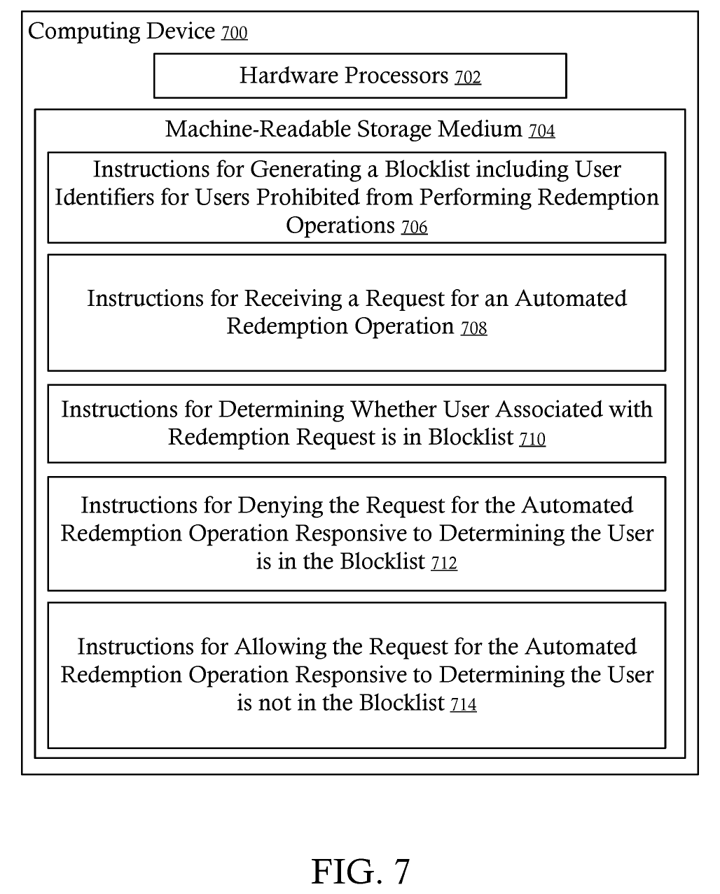

FIGS. 6 and 7 depict example systems 600, 700 that each include a non-transitory, machine-readable medium 604, 704 encoded with example instructions executable by a processing resource 602, 702. In some implementations, the systems 600, 700 may be useful for implementing aspects of the anomaly detection and redemption validation process 130 of FIG. 1, the autoencoder 240 of FIG. 2, or for performing aspects of the methods 400, 500 of FIGS. 4 and/or 5. For example, the instructions encoded on machine-readable medium 604, 704 may be included in instructions 108 of FIG. 1. In some implementations, functionality described with respect to FIG. 1 may be included in the instructions encoded on machine-readable medium 604, 704.

The processing resource 602, 702 may include a microcontroller, a microprocessor, central processing unit core(s), an ASIC, an FPGA, and/or other hardware device suitable for retrieval and/or execution of instructions from the machine-readable medium 604, 704 to perform functions related to various examples. Additionally or alternatively, the processing resource 602, 702 may include or be coupled to electronic circuitry or dedicated logic for performing some or all of the functionality of the instructions described herein.

The machine-readable medium 604, 704 may be any medium suitable for storing executable instructions, such as RAM, ROM, EEPROM, flash memory, a hard disk drive, an optical disc, or the like. In some example implementations, the machine-readable medium 604, 704 may be a tangible non-transitory medium. The machine-readable medium 604, 704 may be disposed within the respective system 600, 700, in which case the executable instructions may be deemed installed or embedded on the system. Alternatively, the machine-readable medium 604, 704 may be a portable (e.g., external) storage medium, and may be part of an installation package.

As described further herein, the machine-readable medium 604, 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 6 or 7.

With reference to FIG. 6, the machine-readable medium 604 includes instructions 606-616. Instructions 606, when executed, cause the processing resource 602 to receive a request for an automated redemption operation. The request includes a plurality of time-series data elements. For example, the request may include a time-series dataset and/or data that include, represent, or embody one or more time-series data elements. In some embodiments, a time-series dataset may be constructed from received data included in a request and/or from additional data obtained by the processing resource 602.

Instructions 608, when executed, cause the processing resource 602 to generate a reconstruction error for the request by applying a trained autoencoder model to the time series dataset associated with the request. The time-series dataset associated with the request may include a generated time-series dataset and/or a time-series dataset included in the request. The trained autoencoder model may include any suitable autoencoder framework, such as a trained variable-length LSTM autoencoder framework. In some embodiments, the trained autoencoder model generates an encoding of the time-series dataset and subsequently generates a reconstruction of the time-series dataset based on the generated encoding. The reconstruction may be compared to the initial time-series dataset associated with the request to generate the reconstruction error. The reconstruction error may be representative of one or more differences between the reconstruction and the initial time-series dataset.

Instructions 610, when executed, cause the processing resource 602 to determine whether the reconstruction error is above (or, in some embodiments, above or equal to) a predetermined threshold. Instructions 612, which are executed in response to determining the reconstruction error is above the predetermined threshold, cause the processing resource 602 to determine whether the request for automated redemption satisfies one or more anomaly rules. For example, as discussed above, an anomaly verifier may implement a rules engine to apply one or more rules to confirm whether the request for automated redemption is anomalous and/or non-anomalous (for example, based on the time-series dataset and/or additional data included in the request).

Instructions 614, which are executed in response to determining that the request for the automated redemption operation satisfies at least one anomaly detection rule (or, conversely, in some embodiments, in response to determining that the request does not satisfy one or more rules indicating the request is non-anomalous), cause the processing resource 602 to prevent or stop processing of the automated redemption operation. Instructions 616, which are executed in response to determining that the reconstruction error is below the predetermined threshold or executed in response to determining the request for the automated redemption operation does not satisfy at least one anomaly detection rule (or, conversely, in some embodiments, in response to determining that the request satisfies one or more rules indicating the request is non-anomalous), cause the processing resource 602 to allow processing of the automated redemption operation.

With reference to FIG. 7, the machine-readable medium 704 includes instructions 706-714. Instructions 706, when executed, cause the processing resource 702 to generate a blocklist including user identifiers for users prohibited from performing automated redemption operations. The blocklist may be generated by applying an anomaly detection and redemption validation process, such as the anomaly detection and redemption validation process 130 discussed above with respect to FIG. 1, to one or more historic redemption requests associated with one or more users. In some embodiments, when the anomaly detection and redemption validation process identifies an anomalous redemption request, a user associated with the anomalous redemption request may be added to the blocklist. The anomaly detection and redemption validation process may require a threshold number of anomalous redemption requests, such as one, two, three, etc. anomalous redemption requests, before a user is added to the blocklist.

Instructions 708, when executed, cause the processing resource 702 to receive a request for an automated redemption operation. The request may be received from any suitable system, such as a redemption system that allows a user to scan or otherwise input data contained in one or more physical elements, e.g., documents. The request may be a request generated during a current (e.g., simultaneously executed) session. The request for the automated redemption operation includes one or more user identifiers, such as a username, an individual name, or other identifying information.

Instructions 710, when executed, cause the processing resource 702 to determine whether the user associated with the redemption request is identified in the blocklist. Instructions 712, which are executed in response to a determination that the user is included in the blocklist, causes the processing resource 702 to prevent processing of the automated redemption operation (e.g., cause the processing resource to not validate the request). Instructions 714, which are executed in response to a determination that the user is not included in the blocklist, cause the processing resource to allow processing of the automated redemption operation (e.g., cause the processing resource 702 to authorize the request).

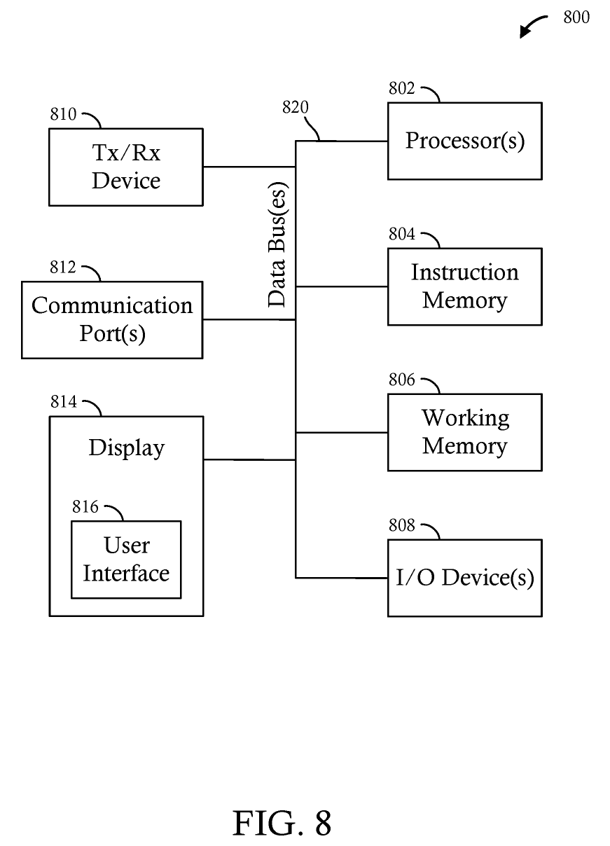

FIG. 8 illustrates a block diagram of a computing device 800, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device.

As shown in FIG. 8, the computing device 800 may include one or more processing resources 802, instruction memory 804, working memory 806, input/output devices 808, transceiver 810, communication port(s) 812, display 814, and/or any other suitable elements each operatively coupled to one or more data buses 820. The data buses 820 allow for communication among the various components. The data buses 820 may include wired or wireless communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same structure or a different structure. The one or more processing resources 802 may include one or more central processing units (CPUs), one or more graphics processing units (GPUs), application-specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an application-specific integrated circuit (ASIC), a field programmable gate array (FPGA), a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein, including separate instruction memory 804 and working memory 806, it will be appreciated that the computing device 800 may include a single memory unit that operates as both instruction memory and working memory. Further, although embodiments are discussed herein, including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for anomaly detection in time-series datasets, as described herein. The instruction set may be stored in any acceptable form of machine-readable instructions, including source code or various appropriate programming languages. Examples of programming languages that may be used to store the instruction set include, but are not limited to, Java, JavaScript, C, C++, C#, Python, Objective-C, Visual Basic, .NET, HTML, CSS, SQL, NoSQL, Rust, Perl, etc. In some embodiments, a compiler or interpreter converts the instruction set into machine-executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example a serial port such as a universal asynchronous receiver/transmitter (UART) connection, a Universal Serial Bus (USB) connection, or any other suitable communication port or connection. In some embodiments, the communication port(s) 812 allow for the programming of executable instructions in the instruction memory 804. In some embodiments, the communication port(s) 812 allow for the transfer (e.g., uploading or downloading) of data, such as machine learning model training data.

In some embodiments, the communication port(s) 812 couple the computing device 800 to a network. The network may include local area networks (LAN), as well as wide area networks (WAN), including, without limitation, Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communication, various devices, and various modes of communication such as wireless communication, wired communication, and combinations of the same.

In some embodiments, the transceiver 810 and/or the communication port(s) 812 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display and may display the user interface 816. The user interface 816 may enable user interaction with input mechanisms and/or input systems, such as a redemption system. In some embodiments, a user may interact with the user interface 816 by engaging the input/output devices 808. In some embodiments, the display 814 may be a touchscreen, where the user interface 816 is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

In some embodiments, the computing device 800 implements one or more modules or engines, each of which is constructed, programmed, configured, or otherwise adapted to autonomously carry out a function or set of functions. A module/engine may include a component or arrangement of components implemented using hardware, such as by an application-specific integrated circuit (ASIC) or field-programmable gate array (FPGA), for example, or as a combination of hardware and software, such as by a microprocessor system and a set of program instructions that adapt the module/engine to implement the particular functionality that (while being executed) transforms the microprocessor system into a special-purpose device. A module/engine may also be implemented as a combination of the two, with certain functions facilitated by hardware alone, and other functions facilitated by a combination of hardware and software. In certain implementations, at least a portion, and in some cases all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs while also implementing the engine using multitasking, multithreading, distributed (e.g., cluster, peer-to-peer or cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more graphical processing units (GPUs), one or more central processing units (CPUs), and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that anomaly detection and redemption verification processes, as disclosed herein, particularly for large datasets intended to be used for redemption processes for large-scale distributed networks, are only possible with the aid of computer-assisted machine-learning algorithms and techniques, such as the trained autoencoder models described herein. In some embodiments, machine learning processes, including autoencoder models, are used to perform operations that cannot practically be performed by a human, either mentally or with assistance, such as encoding and/or decoding of corresponding time-series datasets and/or time-series data elements. It will be appreciated that a variety of machine learning techniques can be used alone or in combination to generate autoencoder models and/or autoencoders, as described above.

By training models utilizing feedback for reconstructions, as discussed above, the trained autoencoders are able to adapt to new circumstances and to detect and extrapolate existing and/or emerging patterns. For example, the disclosed systems and methods allow an autoencoder model to be periodically trained using previously generated outputs and/or ground truth labels to modify the reconstructions over time to adapt to new in-distribution and/or new out-of-distribution time-series datasets or inputs.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
receive a request for an automated redemption operation, wherein the request includes a plurality of time-series data elements;
generate a reconstruction error for the request for the automated redemption operation using a trained autoencoder model that receives the plurality of time-series data elements, wherein the reconstruction error is representative of a difference between the plurality of time-series data elements and a reconstructed plurality of time-series data elements generated by the trained autoencoder model;
determine whether the reconstruction error is above a predetermined threshold;
in response to determining the reconstruction error is above the predetermined threshold, determine whether the request for the automated redemption operation satisfies at least one anomaly detection rule; and
in response to determining the request for the automated redemption operation satisfies the at least one anomaly detection rule, prevent execution of the automated redemption operation.

2. The system of claim 1, wherein each of the plurality of time-series data elements includes scanned data.

3. The system of claim 1, wherein the trained autoencoder model is a variable-length Long Short-Term Memory Network autoencoder.

4. The system of claim 1, wherein the instructions cause the processor to:
receive feedback data including a label for the request for the automated redemption operation;
retrain the trained autoencoder model based at least in part on the feedback data;
receive a request for a second automated redemption operation including a second plurality of time-series data elements; and
generate a second reconstruction error for the request for the second automated redemption operation by applying a retrained autoencoder model to the second plurality of time-series data elements.

5. The system of claim 1, wherein the trained autoencoder model generates an explainability output identifying one or more features of the plurality of time-series data elements having a most significant impact on the reconstruction error.

6. The system of claim 1, wherein the instructions cause the processor to:
receive a request for a second automated redemption operation including a second plurality of time-series data elements, wherein the plurality of time-series data elements and the second plurality of time-series data elements are different lengths; and
generate a second reconstruction error for the request for the second automated redemption operation by applying the trained autoencoder model to the second plurality of time-series data elements.

7. The system of claim 1, wherein the instructions cause the processor to:
prior to receiving the request for the automated redemption operation, receive a set of variable-length time-series data structures;
apply an unsupervised training process to generate the trained autoencoder model based at least in part on the set of variable-length time-series data structures; and
output the trained autoencoder model.

8. The system of claim 1, wherein the trained autoencoder model receives a set of input features representative of a time elapsed between transactions in the plurality of time-series data elements.

9. A computer-implemented method;
receiving a request for an automated redemption operation, wherein the request includes a plurality of time-series data elements;
generating a reconstruction error for the request for the automated redemption operation using a trained autoencoder model that receives the plurality of time-series data elements, wherein the reconstruction error is representative of a difference between the plurality of time-series data elements and a reconstructed plurality of time-series data elements generated by the trained autoencoder model;
determining whether the reconstruction error is above a predetermined threshold;
in response to determining the reconstruction error is above the predetermined threshold, determining whether the request for the automated redemption operation satisfies at least one anomaly detection rule; and
in response to determining the request for the automated redemption operation satisfies the at least one anomaly detection rule, preventing execution of the automated redemption operation.

10. The computer-implemented method of claim 9, wherein each of the plurality of time-series data elements includes scanned data.

11. The computer-implemented method of claim 9, wherein the trained autoencoder model is a variable-length Long Short-Term Memory Network autoencoder.

12. The computer-implemented method of claim 9, comprising:
receiving feedback data including a label for the request for the automated redemption operation;
retraining the trained autoencoder model based at least in part on the feedback data;
receiving a request for a second automated redemption operation including a second plurality of time-series data elements; and
generating a second reconstruction error for the request for the second automated redemption operation by applying a retrained autoencoder model to the second plurality of time-series data elements.

13. The computer-implemented method of claim 9, wherein the trained autoencoder model generates an explainability output identifying one or more features of the plurality of time-series data elements having a most significant impact on the reconstruction error.

14. The computer-implemented method of claim 9, comprising:
receiving a request for a second automated redemption operation including a second plurality of time-series data elements, wherein the plurality of time-series data elements and the second plurality of time-series data elements are different lengths; and
generating a second reconstruction error for the request for the second automated redemption operation by applying the trained autoencoder model to the second plurality of time-series data elements.

15. The computer-implemented method of claim 9, comprising:
prior to receiving the request for the automated redemption operation, receiving a set of variable-length time-series data structures;
applying an unsupervised training process to generate the trained autoencoder model based at least in part on the set of variable-length time-series data structures; and
outputting the trained autoencoder model.

16. The computer-implemented method of claim 9, wherein the trained autoencoder model receives a set of input features representative of a time elapsed between transactions in the plurality of time-series data elements.

17. A non-transitory computer-readable medium storing instructions that, when executed by at least one processor, cause a device to perform operations comprising:
receiving a request for an automated redemption operation, wherein the request includes a plurality of time-series data elements;
generating a reconstruction error for the request for the automated redemption operation using a trained autoencoder model that receives the plurality of time-series data elements, wherein the reconstruction error is representative of a difference between the plurality of time-series data elements and a reconstructed plurality of time-series data elements generated by the trained autoencoder model;
determining whether the reconstruction error is above a predetermined threshold;
in response to determining the reconstruction error is above the predetermined threshold, determining whether the request for the automated redemption operation satisfies at least one anomaly detection rule; and
in response to determining the request for the automated redemption operation satisfies the at least one anomaly detection rule, preventing execution of the automated redemption operation.

18. The non-transitory computer-readable medium of claim 17, wherein each of the plurality of time-series data elements includes scanned data.

19. The non-transitory computer-readable medium of claim 17, wherein the trained autoencoder model is a variable-length Long Short-Term Memory Network autoencoder.

20. The non-transitory computer-readable medium of claim 17, wherein the instructions cause the device to perform operations comprising:
receiving a request for a second automated redemption operation including a second plurality of time-series data elements, wherein the plurality of time-series data elements and the second plurality of time-series data elements are different lengths; and
generating a second reconstruction error for the request for the second automated redemption operation by applying the trained autoencoder model to the second plurality of time-series data elements.
